(19) United States
(12) Patent Application Publication
(10) Pub. No.: US 2016/0334561 A1
(43) Pub. Date: Nov. 17, 2016

(54) BACKLIGHT MODULES AND LIQUID CRYSTAL DEVICES

(71) Applicant: Wuhan China Star Optoelectronics Technology Co., Ltd., Wuhan, Hubei (CN)

(72) Inventor: Jie ZENG, Shenzhen, Guangdong (CN)

(73) Assignee: Wuhan China Star Optotlectronics Technology Co. Ltd., Wuhan, Hubei (CN)

(21) Appl. No.: 14/759,911

(22) PCT Filed: Jun. 17, 2015
(86) PCT No.: PCT/CN2015/081632

§ 371 Date: Jul. 8, 2015

(30) Foreign Application Priority Data
May 13, 2015 (CN) 2015102440814

(51) Int. Cl. F21V 8/00

(52) U.S. Cl. CPC G02B 6/0031; G02B 6/005; G02B 6/0055; G02B 6/009; G02B 6/0068; G02B 6/0065

(57) ABSTRACT

A backlight module and a liquid crystal device are disclosed. The backlight module includes a light guiding plate, a plastic frame, a plurality of light emitting diodes (LEDs), and a reflective sheet comprising a first portion, a second portion bending toward the LEDs and a third portion being bent toward the light guiding plate along the light inlets of the LEDs. Wherein a first portion of the reflective sheet being attached to an undersurface of the light guiding plate, a second portion of the reflective sheet comprising a plurality of openings respectively corresponding to the LEDs, and a third portion of the reflective sheet being attached to an area of the top surface of the light guiding plate, and the area is close to the light inlets of the LEDs. In this way, the light utilization rate is enhanced, and the cost is reduced.

### BACKGROUND OF THE INVENTION

1. Field of the Invention

The present disclosure relates to liquid crystal display technology, and more particularly to a backlight module and a liquid crystal device (LCD).

2. Discussion of the Related Art

As show in FIG. 1, one conventional backlight module 10 includes a light guiding plate 1, a plastic frame 2 arranged close to a lateral side of the light guiding plate 1, a plurality of Light Emitting Diodes 3 (LEDs), a flexible printed circuit (FPC) 4, and a reflective sheet 5. The LED 3 and the FPC 4 are fixed on the light guiding plate 1 and the plastic frame 2 via a shielding tape. The reflective sheet 5 is attached to an undersurface of the light guiding plate 1. In addition, the reflective sheet 5 is adhered to the undersurface of the plastic frame 2 via double-sided tape of mouth shape.

However, as light beams of the LEDs may be leaked out from the gaps between the LEDs, or from the lateral surface or a top surface of the light guiding plate, the light efficiency is low. In addition, the FPC has to be fixed on the light guiding plate and the plastic frame via the shielding tape, which is contrary to the environmental and cost requirement.

### SUMMARY

The object of the invention is to provide a backlight module and a LCD for enhancing light utilization and reducing the cost.

In one aspect, a backlight module includes: a light guiding plate; a plastic frame being arranged close to a lateral surface of the light guiding plate; a plurality of light emitting diodes (LEDs) being arranged between the light guiding plate and the plastic frame, and the LEDs being spaced apart from each other; a reflective sheet comprising a first portion, a second portion bending toward the LEDs, and a third portion being bent toward the light guiding plate along the light inlets of the LEDs; a flexible printed circuit (FPC) being arranged on the plastic frame and the reflective sheet; at least one optical film being arranged on a top surface of the light guiding plate, and the optical film being arranged to be farther away from light inlets of the LEDs; and wherein a first portion of the reflective sheet being attached to an undersurface of the light guiding plate, a second portion of the reflective sheet comprising a plurality of openings respectively corresponding to the LEDs such that each of the LEDs has been embedded to one corresponding opening, and a third portion of the reflective sheet being attached to an area of the top surface of the light guiding plate, and the area is close to the light inlets of the LEDs.

Wherein the top surface of the light guiding plate comprises a first surface, a first slope, and a second surface, and the first slope is bent from the first surface and extends to the second surface, and the first surface has been arranged to be closer to the LEDs than the second surface; and the third portion of the reflective sheet comprises a parallel portion and a bending portion, and the parallel portion is adhered to the first surface of the light guiding plate, and the bending portion is adhered to the first slope of the light guiding plate.

Wherein the first surface, the first slope, and an undersurface of the light guiding plate cooperatively form a horn-shaped space.

Wherein the opening of the second portion of the reflective sheet are rectangular-shaped.

Wherein a gap is formed between the second portion of the reflective sheet and the lateral surface of the light guiding plate.

Wherein the FPC is adhered to the plastic frame and the reflective sheet via adhesive materials.

Wherein the backlight module further comprises a shielding tape arranged above the FPC.

In another aspect, a backlight module includes: a light guiding plate; a plastic frame being arranged close to a lateral surface of the light guiding plate; a plurality of LEDs being arranged between the light guiding plate and the plastic frame, and the LEDs being spaced apart from each other; a reflective sheet comprising a first portion, a second portion bending toward the LEDs, and a third portion being bent toward the light guiding plate along the light inlets of the LEDs; and wherein a first portion of the reflective sheet being attached to an undersurface of the light guiding plate, a second portion of the reflective sheet comprising a plurality of openings respectively corresponding to the LEDs such that each of the LEDs has been embedded to one corresponding opening, and a third portion of the reflective sheet being attached to an area of the top surface of the light guiding plate, and the area is close to the light inlets of the LEDs.

Wherein the FPC is adhered to the plastic frame and the reflective sheet via adhesive materials.

Wherein the top surface of the light guiding plate comprises a first surface, a first slope, and a second surface, and the first slope is bent from the first surface and extends to the second surface, and the first surface has been arranged to be closer to the LEDs than the second surface; and the third portion of the reflective sheet comprises a parallel portion and a bending portion, and the parallel portion is adhered to the first surface of the light guiding plate, and the bending portion is adhered to the first slope of the light guiding plate.

Wherein the first surface, the first slope, and an undersurface of the light guiding plate cooperatively form a horn-shaped space.

Wherein the opening of the second portion of the reflective sheet are rectangular-shaped.

Wherein a gap is formed between the second portion of the reflective sheet and the lateral surface of the light guiding plate.

Wherein the FPC is adhered to the plastic frame and the reflective sheet via adhesive materials.

Wherein the backlight module further comprises a shielding tape arranged above the FPC.

Wherein the backlight module further comprises at least one optical film being arranged on a top surface of the light guiding plate, and the optical film being arranged to be farther away from light inlets of the LEDs.

In another aspect, a liquid crystal device comprises one of the above backlight modules.

In view of the above, the reflective sheet includes a first portion, a second portion and a third portion. The first portion of the reflective sheet is attached to the undersurface of the light guiding plate. The second portion of the reflective sheet is bent along a direction from the first portion toward the LEDs. The second portion includes a plurality of openings corresponding to the LEDs. As such, each of the LEDs has been embedded to one corresponding opening. The third portion may extend by bending the second portion from the light inlets of the LEDs along the light guiding plate. In addition, the third portion of the reflective sheet is attached to an area of a top surface of the light guiding plate, and the area is close to light inlets of the LEDs. As each of the LEDs has been embedded to one corresponding opening of the second portion of the reflective sheet, the light beams leaked from the area between the gaps of the LEDs may be reflected by the reflective sheet arranged between the LEDs. In this way, the light utilization is enhanced.

### BRIEF DESCRIPTION OF THE DRAWINGS

FIG. 1 is a cross sectional view of the conventional backlight module.

FIG. 2 is a cross sectional view of the backlight module in accordance with one embodiment.

FIG. 3 is a schematic view of the reflective sheet of the backlight module of FIG. 2.

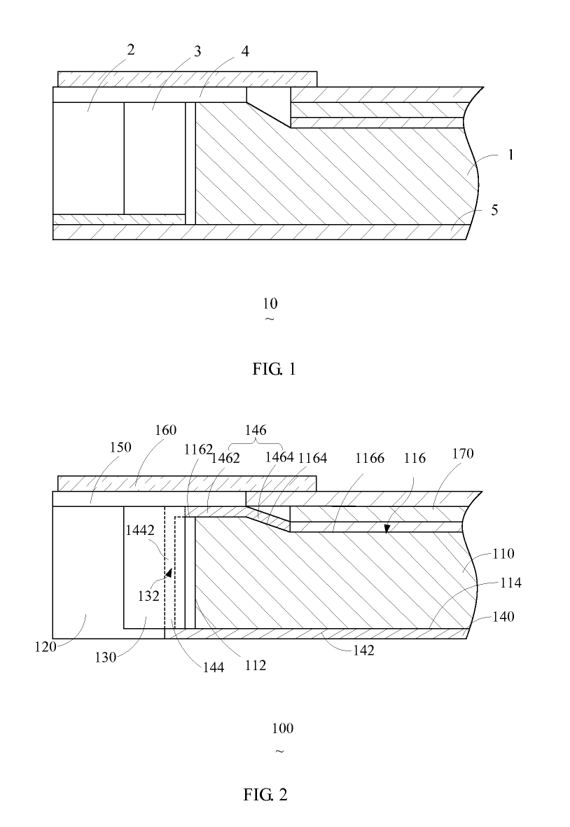

### DETAILED DESCRIPTION OF THE EMBODIMENTS

Embodiments of the invention will now be described more fully hereinafter with reference to the accompanying drawings, in which embodiments of the invention are shown.

FIG. 2 is a cross sectional view of the backlight module in accordance with one embodiment. The backlight module 100 includes a light guiding plate 110, a plastic frame 120, a plurality of LEDs 130, and a reflective sheet 140.

The light guiding plate 110 transforms a point source or a line light source emitted by the LEDs 130 into a surface light source. The light guiding plate 110 may be made by any materials that have been adopted, such as optical-grade PMMA.

The plastic frame 120 is arranged close to a lateral surface 112 of the light guiding plate 110, and the plastic frame 120 may support and protect the light guiding plate 110.

The LEDs 130 are arranged between the light guiding plate 110 and the plastic frame 120, and the LEDs 130 are spaced apart from each other.

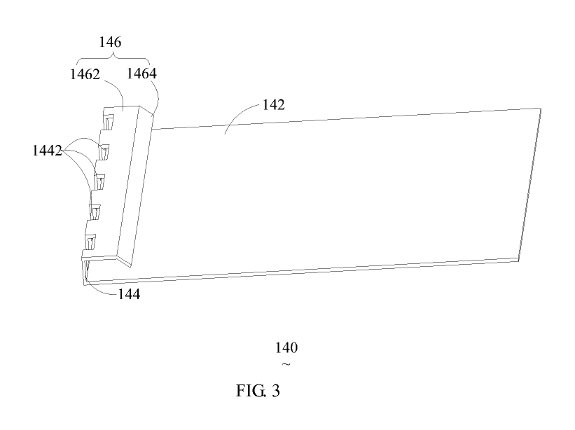

FIG. 3 is a schematic view of the reflective sheet of the backlight module of FIG. 2. The reflective sheet 140 includes a first portion 142, a second portion 144, and a third portion 146. The second portion 144 extends from the first portion 142 along a direction toward the LEDs 130 and then is bent. The third portion 146 may extend by bending the second portion 144 from the light inlets 132 of the LEDs 130 along the light guiding plate 110.

The first portion 142 of the reflective sheet 140 is attached to an undersurface 114 of the light guiding plate 110. The second portion 144 of the reflective sheet 140 includes a plurality of openings 1442 respectively corresponding to the LEDs 130. As such, each of the LEDs 130 has been embedded to one corresponding opening 1442. The third portion 146 of the reflective sheet 140 is attached to an area of a top surface 116 of the light guiding plate 110, and the area is close to light inlets 132 of the LEDs 130.

Compared to the conventional technology, the reflective sheet 140 of the backlight module 100 includes the first portion 142, the second portion 144, and the third portion 146. The first portion 142 of the reflective sheet 140 is attached to an undersurface 114 of the light guiding plate 110. The second portion 144 extends from the first portion 142 along a direction toward the LEDs 130 and then is bent. The second portion 144 of the reflective sheet 140 includes a plurality of openings 1442 respectively corresponding to the LEDs 130. As such, each of the LEDs 130 has been embedded to one corresponding opening 1442. The third portion 146 may extend by bending the second portion 144 from the light inlets 132 of the LEDs 130 along the light guiding plate 110. In addition, the third portion 146 may attach on the top surface 116 of the light guiding plate 110, which is close to the light inlets 132 of the LEDs 130.

As each of the LEDs 130 has been embedded to one corresponding opening 1442 of the second portion 144 of the reflective sheet 140, the light beams leaked from the area between the gaps of the LEDs 130 may be reflected by the reflective sheet 140 arranged between the LEDs 130. In addition, the light beams leaked from the lateral surface 112 or the top surface 116 of the light guiding plate 110 may be reflected by the third portion 146 of the reflective sheet 140 so as to enhance the light utilization.

In addition, the backlight module 100 further includes a flexible printed circuit (FPC) 150 being arranged on the plastic frame 120 and the reflective sheet 140. The FPC 150 may be made by materials, including but not limited to, polyimide or polyester film.

The FPC 150 may be adhered to the plastic frame 120 or the reflective sheet 140 by adhesive technology. The adhesive technology relates to the method of adopting adhesive materials for bonding two kinds of objects. The adhesive technology may include, but not limited to, coating an adhesive layer or adopting a double-sided adhesive tape. In this embodiment, the FPC 150 is adhered on the plastic frame 120 or the reflective sheet 140 by the double-sided adhesive tape.

In addition, the FPC 150 further includes a shielding tape 160. It can be understood that the shielding tape 160 may be omitted for the reason that the FPC 150 has been adhered on the reflective sheet 140 and thus the light beams leaked from the LEDs 130 have been reflected by the reflective sheet 140. In other embodiments, the shielding tape 160 is arranged on the FPC 150 for preventing a portion of the light beams from being leaked out and for reflecting the leaked light beams. As such, the light utilization is enhanced.

The top surface 116 of the light guiding plate 110 includes a first surface 1162, a first slope 1164, and a second surface 1166. The first slope 1164 is bent from the first surface 1162 and then extends to the second surface 1166. The first surface 1162 has been arranged to be closer to the LEDs 130 than the second surface 1166.

Correspondingly, the third portion 146 of the reflective sheet 140 includes a parallel portion 1462 and a bending portion 1464. The parallel portion 1462 is adhered to the first surface 1162 of the light guiding plate 110. The bending portion 1464 is adhered to the first slope 1164.

In the embodiment, the first surface 1162 and the first slope 1164 of the light guiding plate 110, and the undersurface 114 of the light guiding plate 110 cooperatively constitute a horn-shaped space. It can be understood that the space cooperatively defined by the first surface 1162 and the first slope 1164 of the light guiding plate 110, and the undersurface 114 of the light guiding plate 110 may be of other shapes, including but not limited to trapezium or rectangular. The shape of the reflective sheet 140 corresponds to the shape of the space cooperatively defined by the first surface 1162 and the first slope 1164 of the light guiding plate 110, and the undersurface 114 of the light guiding plate 110 such that the reflective sheet 140 may be closely bonded with the light guiding plate 110. In this way, the light utilization is enhanced.

In addition, the opening 1442 of the second portion 144 of the reflective sheet 140 may be rectangular-shaped such that each of the LEDs 130 has been embedded to one corresponding opening 1442. It can be understood that the shape of the opening 1442 is configured to be corresponding to the shape of the LEDs 130 such that each of the LEDs 130 may been embedded to one corresponding opening 1442. In this way, the area between the openings 1442 may be closely bonded with the gaps between the LEDs 130. Thus, the light beams leaked from the gaps between the LEDs 130 may be reflected by the reflective sheet 140 as much as possible.

In the embodiment, there is still a gap between the second portion 144 of the reflective sheet 140 and the lateral surface 112 of the light guiding plate 110. In other embodiments, the second portion 144 of the reflective sheet 140 may be closely bonded with the lateral surface 112 of the light guiding plate 110.

It can be understood that, in an example, the backlight module 100 further includes an optical film 170 being arranged on the top surface 116 of the light guiding plate 110. The optical film 170 is arranged to be farther away from the light inlets 132 of the LEDs 130.

In view of the above, the FPC 150 is adhered to the plastic frame 120 and the reflective sheet 140 via adhesive technology. The light beams leaked from the LEDs 130 may be reflected back by the reflective sheet 140 so as to omit the shielding tape adopted for fixing the FPC on the light guiding plate and the plastic frame. In this way, the cost is reduced and such configuration conforms to the environmental requirement. In addition, the shape of the reflective sheet 140 corresponds to the shape of the space cooperatively defined by the first surface 1162 and the first slope 1164 of the light guiding plate 110, and the undersurface 114 of the light guiding plate 110 such that the reflective sheet 140 may be closely bonded with the light guiding plate 110. In addition, the shape of the opening 1442 is configured to be corresponding to the shape of the LEDs 130 such that the light beams leaked from the gaps between the LEDs 130 may be reflected by the reflective sheet 140 as much as possible, which enhances the light utilization.

According to the present disclosure, the LCD includes a backlight module, and the backlight module may be one of the above-mentioned backlight module.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A backlight module, comprising:
a light guiding plate;
a plastic frame being arranged close to a lateral surface of the light guiding plate;
a plurality of light emitting diodes (LEDs) being arranged between the light guiding plate and the plastic frame, and the LEDs being spaced apart from each other;
a reflective sheet comprising a first portion, a second portion bending toward the LEDs, and a third portion being bent toward the light guiding plate along the light inlets of the LEDs;
a flexible printed circuit (FPC) being arranged on the plastic frame and the reflective sheet;
at least one optical film being arranged on a top surface of the light guiding plate, and the optical film being arranged to be farther away from light inlets of the LEDs; and
wherein a first portion of the reflective sheet being attached to an undersurface of the light guiding plate, a second portion of the reflective sheet comprising a plurality of openings respectively corresponding to the LEDs such that each of the LEDs has been embedded to one corresponding opening, and a third portion of the reflective sheet being attached to an area of the top surface of the light guiding plate, and the area is close to the light inlets of the LEDs.

2. The backlight module as claimed in claim 1, wherein the top surface of the light guiding plate comprises a first surface, a first slope, and a second surface, and the first slope is bent from the first surface and extends to the second surface, and the first surface has been arranged to be closer to the LEDs than the second surface; and
the third portion of the reflective sheet comprises a parallel portion and a bending portion, and the parallel portion is adhered to the first surface of the light guiding plate, and the bending portion is adhered to the first slope of the light guiding plate.

3. The backlight module as claimed in claim 2, wherein the first surface, the first slope, and an undersurface of the light guiding plate cooperatively form a horn-shaped space.

4. The backlight module as claimed in claim 1, wherein the opening of the second portion of the reflective sheet are rectangular-shaped.

5. The backlight module as claimed in claim 1, wherein a gap is formed between the second portion of the reflective sheet and the lateral surface of the light guiding plate.

6. The backlight module as claimed in claim 1, wherein the FPC is adhered to the plastic frame and the reflective sheet via adhesive materials.

7. The backlight module as claimed in claim 1, wherein the backlight module further comprises a shielding tape arranged above the FPC.

8. A backlight module, comprising:
a light guiding plate;
a plastic frame being arranged close to a lateral surface of the light guiding plate;
a plurality of LEDs being arranged between the light guiding plate and the plastic frame, and the LEDs being spaced apart from each other;
a reflective sheet comprising a first portion, a second portion bending toward the LEDs, and a third portion being bent toward the light guiding plate along the light inlets of the LEDs; and
wherein a first portion of the reflective sheet being attached to an undersurface of the light guiding plate, a second portion of the reflective sheet comprising a plurality of openings respectively corresponding to the LEDs such that each of the LEDs has been embedded to one corresponding opening, and a third portion of the reflective sheet being attached to an area of the top surface of the light guiding plate, and the area is close to the light inlets of the LEDs.

9. The backlight module as claimed in claim 8, wherein the FPC is adhered to the plastic frame and the reflective sheet via adhesive materials.

10. The backlight module as claimed in claim 9, wherein the top surface of the light guiding plate comprises a first surface, a first slope, and a second surface, and the first slope is bent from the first surface and extends to the second surface, and the first surface has been arranged to be closer to the LEDs than the second surface; and
the third portion of the reflective sheet comprises a parallel portion and a bending portion, and the parallel portion is adhered to the first surface of the light guiding plate, and the bending portion is adhered to the first slope of the light guiding plate.

11. The backlight module as claimed in claim 10, wherein the first surface, the first slope, and an undersurface of the light guiding plate cooperatively form a horn-shaped space.

12. The backlight module as claimed in claim 9, wherein the opening of the second portion of the reflective sheet are rectangular-shaped.

13. The backlight module as claimed in claim 9, wherein a gap is formed between the second portion of the reflective sheet and the lateral surface of the light guiding plate.

14. The backlight module as claimed in claim 9, wherein the FPC is adhered to the plastic frame and the reflective sheet via adhesive materials.

15. The backlight module as claimed in claim 9, wherein the backlight module further comprises a shielding tape arranged above the FPC.

16. The backlight module as claimed in claim 8, wherein the backlight module further comprises at least one optical film being arranged on a top surface of the light guiding plate, and the optical film being arranged to be farther away from light inlets of the LEDs.

17. A liquid crystal device comprises a backlight module of claim 8.
